(19) United States
(12) Patent Application Publication
(10) Pub. No.: US 2012/0118143 A1
(43) Pub. Date: May 17, 2012

(54) APPARATUS AND METHOD FOR DEHUMIDIFYING AIR

(76) Inventor: Ronald E. Foreman, Delta (CA)

(21) Appl. No.: 12/947,942

(22) Filed: Nov. 17, 2010

(51) Int. Cl. B01D 53/02; B01D 53/30

(52) U.S. Cl. 95/10; 96/108; 96/116; 96/111; 96/112; 96/134; 95/26; 95/14

(57) ABSTRACT

An apparatus and method for dehumidifying a desired area using a desiccant dehumidifier. The desiccant dehumidifier of the present invention provides substantial advantages over known desiccant dehumidifiers in terms of simplified manufacture and improved efficiency. The dehumidifier of the present invention includes a single chamber with an intake and an exhaust end, a desiccant, a fan and a heater located in the chamber, and one or more regulators for directing intake and/or output of air in relation to the chamber. This configuration does not require a rotor motor or cycling multichamber apparatus in order to change operation of the apparatus from drying air to reactivating the desiccant.

### FIELD OF THE INVENTION

The present invention relates generally to an apparatus and method for dehumidifying air. More specifically, the apparatus and method use a honeycomb desiccant to remove water vapor from the air.

### BACKGROUND OF THE INVENTION

Excess humidity can be physically uncomfortable at high temperatures. Humidity can also lead to diseases associated with the growth of molds or cause damage to structures. As such, dehumidifiers are often used in private and public buildings, including individual residences as well as workplaces.

One type of dehumidifier is a desiccant dehumidifier. These types of dehumidifiers use desiccants to remove moisture from the air by exposing a desiccant material to an air stream that has a high relative humidity level. The desiccant material attracts and retains some water vapor from the air through adsorption and drier air is released. Adsorption is a reversible physical phenomenon in which neither the adsorbent nor the adsorbate are changed in structure. Rather, the adsorbate is bound to the surface of the particles of the adsorbent.

Substances that are considered to be desiccant materials have a natural affinity for adsorbing water vapor. Industrial and household desiccant dehumidifiers are based on two primary forms of desiccants: (1) solid, rigid, and/or honeycomb blocks and (2) granular or powder systems. The best desiccants are materials which combine large surface areas with strong surface forces to maximize adsorption. The most common materials that possess this combination are silica gels, activated alumina, activated charcoal, and molecular sieves; although myriad other desiccants are also known in the art.

The performance of any desiccant varies with temperature and both relative humidity and absolute humidity of the surrounding environment. If the desiccant is brought into contact with environments that have low humidity levels, then desiccant materials will have comparably low moisture content. When in areas of high relative humidity these materials will quickly develop high moisture content. This adsorption can be reversed as a function of temperature. In other words, adsorbed moisture may be freed from the desiccant by applying heat to the system (reactivation). When the desiccant cools, its capacity for adsorption will increase again, and the desiccant can be reused for conditioning.

All desiccant dehumidifier systems share the need to recharge, regenerate, or reactivate the desiccant once it has adsorbed moisture because at some point the desiccant adsorbs so much moisture that it no longer draws out water vapor from the air. At that point, the desiccant will need to be dried or reactivated before being used to dry air again. The reactivation may be active (where heat is applied to speed up the reactivation of the desiccant) or passive (where some other method of reactivation is used).

Currently, the most commonly used type of active reactivation desiccant systems employs a desiccant rotor motor to regenerate the desiccant. The rotating desiccant rotor is exposed to two air streams, process air (which is being dehumidified) and reactivation air (which is made wet or humidified in the desiccant reactivation process). In a typical application, the rotor is exposed to the reactivation air for roughly 25% of the cycle, with approximately 75% of the cycle being used for active dehumidifying or conditioning. Rotating desiccant systems tend to be employed in commercial settings as they are relatively large and expensive, and can require significant maintenance. Smaller versions may also be used; however, they are relatively expensive and therefore not widely used. Moreover, they are sufficiently difficult to install and require a certain amount of space to enable effective movement of the desiccant rotor that they are not well suited for more confined spaces with dehumidification needs including, but not limited to individual rooms, garages, boats, yachts and recreational vehicles, for example.

U.S. Pat. No. 5,980,615 replaces the desiccant rotor of standard desiccant dehumidifiers with a multiple chamber (six chambers total) with two fixed desiccant blocks, and uses two fans and a rotating disk to cycle process and reactivation air between the two desiccant blocks on a fixed interval. In this system the two desiccant chambers cycle alternately, and each desiccant block is drying or conditioning only 50% of the time. As such, the system described is substantially less efficient than the standard desiccant rotor systems.

Although these types of desiccant dehumidifiers are functional, there exists a continuing need in the art to develop simpler and more efficient desiccant dehumidifiers. The present inventor has solved these problems by providing a simplified desiccant dehumidifying apparatus that does not require a rotor based circulation system. The apparatus is suitable for use in a wide range of applications including, but not limited to, private homes and other locations that may be smaller than public buildings, for example individual rooms or spaces, recreational vehicles, boats and yachts, and garages.

### SUMMARY OF THE INVENTION

It is an object of the present invention to provide a simplified desiccant dehumidifier that may be purposed in several ways to condition air. Another object of the invention is to provide a method for dehumidifying or conditioning air using a simplified desiccant dehumidifier. The dehumidifier apparatus of the present invention is a single chamber apparatus that, contrary to desiccant systems known in the art, does not require a rotor motor or a rotating disc to cycle between the drying and reactivation cycles. The apparatus of the present invention includes a single desiccant block, a single fan, and a single reactivation heater. The apparatus does not require multiple desiccant blocks. The apparatus of the present invention can be configured to operate with a control process that permits, if desired, complete control/separation of the process and reactivation cycles so as to achieve optimum efficiency of the device.

In one embodiment, the apparatus uses two separate air streams for intake and output. That is, in this embodiment an intake manifold has two intake flows, one for intake air to be dried and one for intake air used to dry the desiccant. An output manifold provides two output flows, one for dry air to be returned and one for wet air exhaust. In another embodiment, the apparatus replaces the intake manifold with a single duct. In this embodiment, the interior air supply may also be used to remove moisture. This embodiment may be less efficient than the embodiment with two intakes, but is simpler to manufacture.

In variations of the two intake and single duct embodiments of the invention, the desiccant block may be shaped to maximize surface area and decrease the static pressure of air flow across the block. This form permits great flexibility in choice of fans as the static pressure across the desiccant block can be a limiting factor in fan selection.

It is another object of the present invention to develop a desiccant apparatus and method which only exposes the desiccant block to process air for a specific period of time before exposing the same desiccant block to reactivation air. This sequential cycling of the desiccant block can be varied depending on time, temperature, or humidity, or a combination thereof A cycling process with 75% of the time spent on drying and 25% spent on the reactivation cycle would equal the efficiency of most rotor based systems known in the art. The design incorporates the ability to optimize the ratio between drying time and reactivation time, which could result in higher efficiency than has been attained for rotor based units. The cycling process can also be modulated so that the apparatus is used only as an air circulator, i.e., with no drying cycle. The apparatus operated in this manner may be advantageous for use in semi-closed or closed spaces, such as relatively large computer cabinets, electronics rooms, vans and the like where effective air circulation is desired using a device that has a relatively minimal impact on space usage. It can be used to circulate cooling air and/or to circulate warming air, which may include use of the heater of the present invention.

The desiccant dehumidifier apparatus and method of the present invention offer significant advantages over desiccant dehumidifiers known in the art. The simpler design is easier and less costly to manufacture. Further, it is believed that the simplified apparatus can be configured to approach, or exceed, efficiencies of other systems known in the art by providing control over separation and timing of the conditioning and reactivation cycles. In addition, the simplified apparatus and method of the present invention can be easily scaled to much smaller applications than any systems known in the art permit. As such, the apparatus and method of the present application can be used easily in small spaces such as homes, rooms of homes, garages, boats, yachts and recreational vehicles, for example.

These and other advantages of the present invention will become more readily apparent upon review of the following detailed description, the accompanying drawings, and the appended claims.

### BRIEF DESCRIPTION OF THE DRAWINGS

FIG. 1A schematically illustrates a first embodiment of the desiccant dehumidifier apparatus of the present invention and shows the air flow and position of the valves during the conditioning cycle.

FIG. 1B is the same embodiment of the apparatus shown in FIG. 1A, but the air flow and position of the valves of the reactivation cycle is illustrated.

FIG. 2 is a three dimensional view of the embodiment of the desiccant dehumidifier shown in FIGS. 1A and 1B showing the interior elements of the apparatus.

FIG. 3A schematically illustrates a second embodiment of the desiccant dehumidifier apparatus of the present invention and shows the air flow and position of the valves during the conditioning cycle.

FIG. 3B is the same embodiment of the apparatus shown in FIG. 3A, but the air flow and the position of the valves of the reactivation cycle is illustrated.

FIG. 3C is the same embodiment of the apparatus shown in FIGS. 3A and 3B, but the air flow and the position of the valves during the air circulation option is illustrated.

FIG. 4A is a schematic illustration of a third embodiment of the desiccant dehumidifier apparatus of the present invention and shows the air flow and position of the valves during the conditioning cycle.

FIG. 4B is the same embodiment of the apparatus shown in FIG. 4A, but the air flow and position of the valves of the reactivation cycle is illustrated.

FIG. 5 is a three dimensional view of the embodiment of the desiccant dehumidifier shown in FIGS. 4A and 4B showing the interior elements of the apparatus.

FIG. 6A is a schematic illustration of a fourth embodiment of the desiccant dehumidifier apparatus of the present invention and shows the air flow and position of the valves during the conditioning cycle.

FIG. 6B is the same embodiment of the apparatus shown in FIG. 6A, but the air flow and position of the valves of the reactivation cycle is illustrated.

FIG. 7 is a three dimensional view of the embodiment of the desiccant dehumidifier shown in FIGS. 6A and 6B showing the interior elements of the apparatus.

FIGS. 8A and 8B are a flow chart illustrating the steps of the method of controlling the desiccant dehumidifying apparatus of the present invention when not using an external sensor as part of the control process.

FIGS. 9A and 9B are a flow chart illustrating the steps of the method of controlling the desiccant dehumidifying apparatus of the present invention when using an external sensor as part of the control process.

### DETAILED DESCRIPTION OF THE PREFERRED EMBODIMENTS

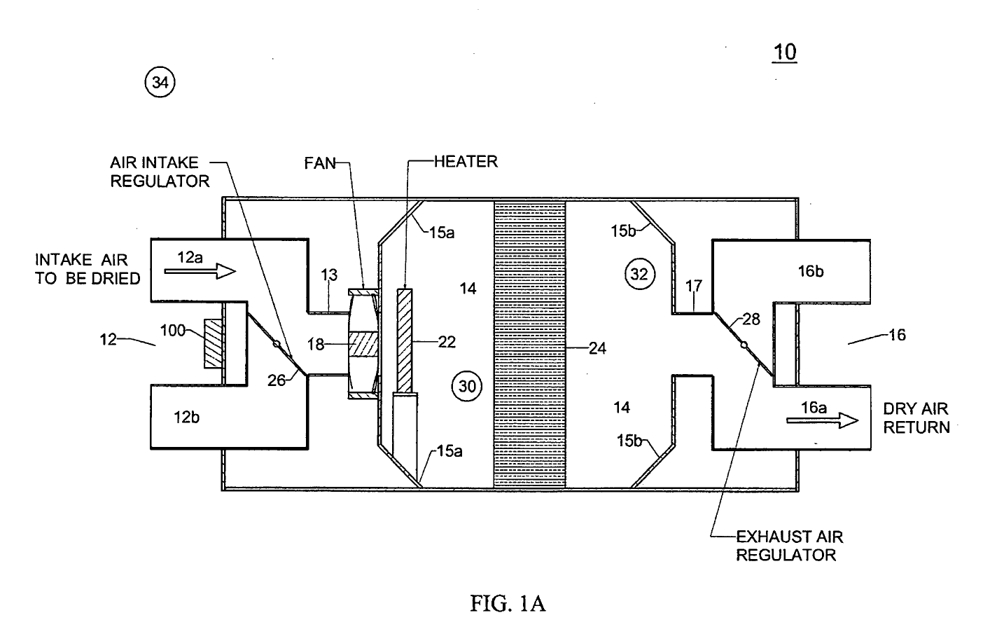

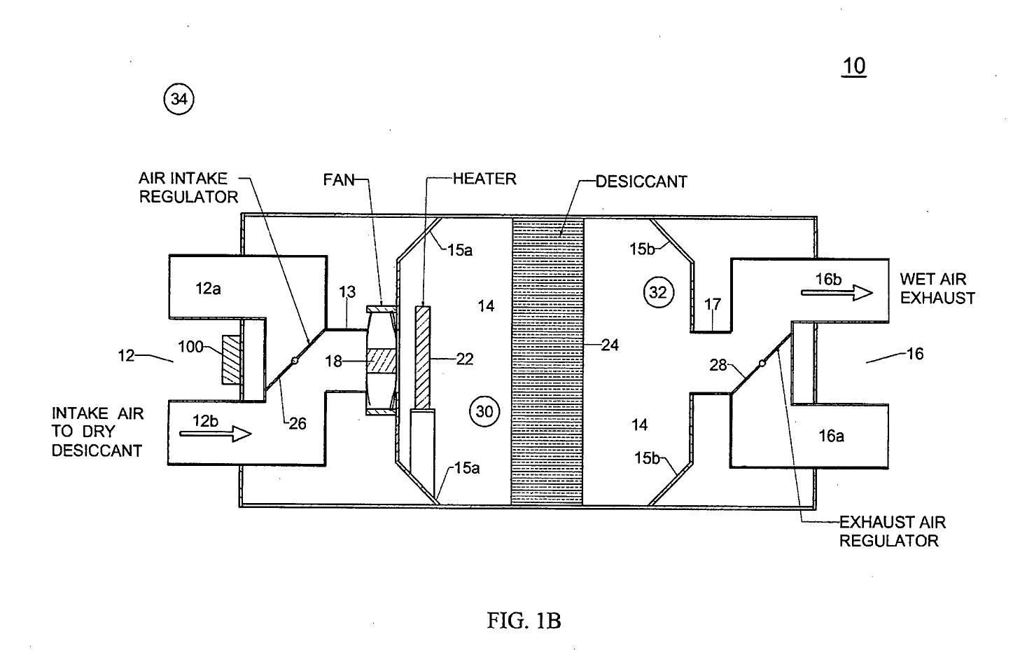

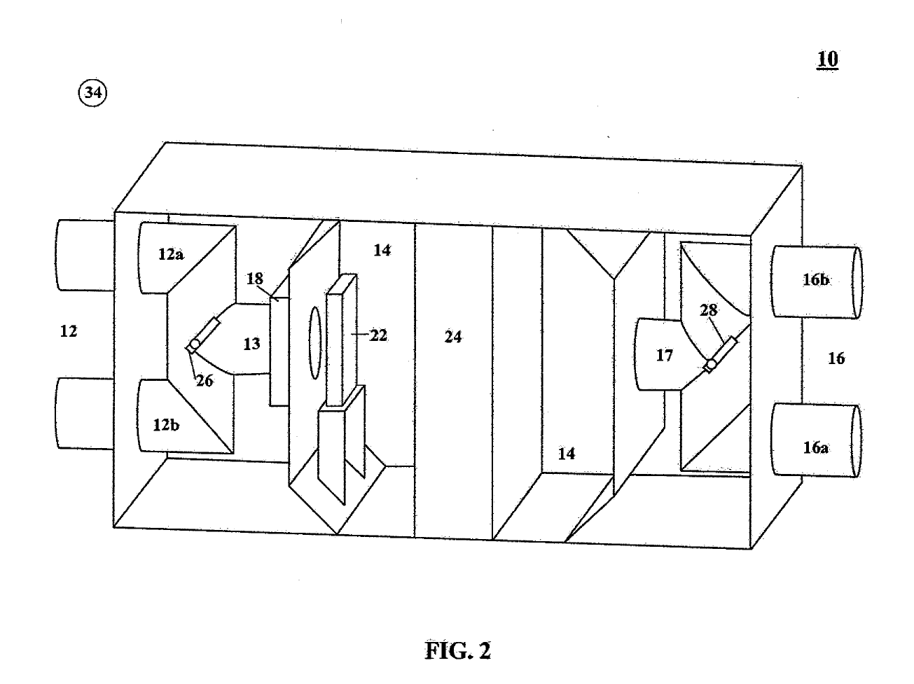

The present invention is an apparatus and method to remove water vapor from air using a desiccant dehumidifier. A first embodiment of a desiccant dehumidifier apparatus 10 of the present invention is shown in FIGS. 1A-2. The apparatus 10 has an intake for receiving air, such as air to be conditioned, and an output for transmitting air, such as conditioned air. For purposes of the description of all embodiments of the present invention the intake is the location of the apparatus where air enters the apparatus and the output is the location of the apparatus where air exits the apparatus. The apparatus 10 of FIGS. 1A-2 includes a two-duct intake manifold 12 used to draw in air from the intake, which air is to be conditioned; that is dried or otherwise heated, cooled or changed from its current state, by the apparatus 10. The intake manifold 12 includes a first intake duct 12a and a second intake duct 12b. The intake manifold 12 is connected to or integral with an intake end of chamber 14 of the apparatus 10. An output end of the chamber 14 is connected to or integral with a two-duct output manifold 16 and is used to exhaust conditioned air from the apparatus 10 at the apparatus output. The output manifold 16 includes a first output duct 16a and a second output duct 16b. The intake manifold 12 and output manifold 16 are configured to enable the transfer of air through the chamber by way of intake regulator 26 and output regulator 28. Either or both of the regulators 26 and 28 may be any device suitable to be controlled and suitable to be used to direct the flow of air where desired. For example, either or both of the regulators 26 and 28 may be a valve. Any suitable valves known in the art may be used, such as butterfly, flapper, leaf, gate, sliding plate, or ball valves. While the apparatus 10 of FIGS. 1A-2 is illustrated as a rectangular structure, and the other embodiments of the apparatus are similarly shaped, it is to be understood that the structure may be of other shapes, which shapes are selectable as a function of the location of the apparatus and/or the particular dehumidification needs. For example, and not intended to be limiting, the apparatus of the present invention may be a cylinder or bell-shaped as a way to aid in air flow shaping or in achieving application specific fitting requirements. In addition, the interior of the apparatus may be configured to optimize air flow efficiency. For example, as shown in FIGS. 1A and 1B, the chamber 14 includes internal intake angled flanges 15a for directing air flow to the entire surface area of a device for drying air, such as desiccant 24, and internal output angled flanges 15b for guiding air from the desiccant 24 to the output manifold 16.

In this first embodiment, the intake manifold 12 is configured so that each one of the ducts 12a and 12b has access to different air supplies, depending on the position of the regulator 26. For example, if the apparatus 10 is to be used in a boat, duct 12a of the intake manifold 12 may be configured to draw in air from within one or more compartments of the boat, and this is the air to be dried. Duct 12b of the intake manifold 12 may be configured to draw in air from outside the boat, and this is the air which is used to reactivate the desiccant 24 in the apparatus. Similarly, the output manifold 16 may be configured so that duct 16a exhausts conditioned or dried air into the area to be conditioned, and duct 16b exhausts wet air released after regenerating the desiccant into another space, such as outside of the boat, for example.

The apparatus 10 also includes a device for moving air, such as fan 18, a device for warming air, such as heater 22, and desiccant 24. Those skilled in the art will recognize that any suitable fans and heaters known in the art can be used in the apparatus 10. A suitable fan is any fan providing good static pressure performance for the particular airflow desired, as well as desiccant thickness and size. High pressure fans are preferable over low pressure fans of the type that may be used in computers and space heaters, for example. Examples of suitable fans include, but are not limited to, the series 8200 J axial fans and motorized impellers, both available from ebm-papst, Inc., of Farmington, Conn., as well as the Rotron Diplomat series of impellers available from Comair Rotron Fan Company Ltd. of Shanghai, China. A suitable heater is any heater are that can provide a temperature modification compatible with the intended function of the apparatus for the space to be dehumidified, or at least for which particular air circulation characteristics are desired. One type of heater suitable for this purpose is a PTC ceramic heater having a fixed temperature at the heater element surface, which also makes it relatively simple to calculate the optimum heater size for the particular design size of the apparatus 10. It is to be noted that the heater is preferably incorporated into common intake duct 13. It may also be located elsewhere in the chamber 14, and there may be more than one of the heaters 22, dependent upon the particular application and space available. Examples of suitable fans include, but are not limited to, PTC heaters, finned resistor air heaters, tubular and finned heaters, flatwire and open coil heaters, as well others known to those of skill in this art. Similarly, any suitable desiccant 24 may be used. For example, the desiccant 24 may be a honeycomb block desiccant. Particularly suitable desiccants 24 are solid materials which combine large surface areas with strong surface forces to maximize adsorption. The most common materials that possess this combination are silica gels, activated alumina, activated charcoal, and molecular sieves, although those skilled in the art can easily conceive of other suitable desiccants. Examples of suitable desiccants include, but are not limited to, honeycomb silica gel desiccants provided by Proflute AB of Sweden, Seibu Giken DTS AB of Japan and NovelAire Technologies of Baton Rouge, Louisiana. It is to be noted that other desiccant materials may also be suitable, provided they are selected to achieve the desired dehumidification function.

The apparatus 10 of the present invention may also include one or more sensors for measuring temperature, humidity, or both. The apparatus 10 includes three sensors 30, 32, and 34. It is to be noted that the sensors 30/32/34 may be any sort of thermistor, thermocouple, or the like capable of measuring temperature changes, that is couplable to a controller, microprocessor or the like for transfer and processing of the sensed information as part of the dehumidification control process. Sensors 30 and 32 are placed on opposite sides of the desiccant 24 within the chamber 14, and sensor 34 may either be placed remotely from the apparatus 10 or attached to apparatus 10 to measure the temperature and/or humidity of the air in the environment external to the apparatus 10. An example of a suitable sensor performing the function of the external sensor 34 is a commercially available humidistat that may be set in a dehumidistat mode. Examples include, but are not limited to, the TrueIAQ and H46C1166 sensors available from Honeywell International of Morristown, N.J., the FH2O sensor available from Fantech of Lenexa, Kans., and the DH10 sensor available from Tjernlund of White Bear Lake, Minn. Those of skill in the art will recognize that other sensors will be suitable for the indicated purpose, including customized sensors with associated programmed controllers.

During the drying cycle of the apparatus 10 the fan 18 is on, and the heater 22 is off. As shown in FIG. 1A, when the apparatus 10 is switched on, the regulator 26 position should move or reset to the position where the intake duct 12a is arranged to permit the drawing in of air to be dried and regulator 28 is set so that the dried air is exhausted through duct 16a. Intake air to be dried is brought through the intake manifold 12 at common intake duct 13 and pushed by the fan 18 through the desiccant 24. The desiccant 24 removes water vapor from the air by adsorption, and dry air is exhausted through the output manifold 16 at common output duct 17. The duration of this cycle may be determined by one or more adjustable timers and depends on the dimensions and volume of the desiccant 24. Alternatively, the duration of this cycle may be determined by changes sensed between sensors 30 and 32, optionally together with the measurements sensed by sensor 34.

After the drying cycle is completed, regulator 26 switches the air source to external air and the heater 22 is turned on to warm this air before it passes through the desiccant 24. The reactivation cycle using the apparatus 10 of the present invention is shown in FIG. 1B. During the reactivation cycle of the apparatus 10, the fan 18 and heater 22 are both on. Intake air to dry the desiccant 24 is drawn through the intake manifold 12 with the regulator 26 in the position shown in that figure so that external air is drawn into the apparatus 10 through duct 12b. The air is heated by the heater 22 and moved by the fan 18 through the desiccant 24. The desiccant 24 releases water to the warmed air, and wet air is exhausted through the output manifold 16 at duct 16b. The wet air is exhausted outside the environment being dried (such as outside of a recreational vehicle, for example). The duration of this cycle may be determined by one or more adjustable timers and depends on the dimensions and volume of the desiccant 24. The duration of the reactivation cycle will be determined by (a) the temperature at sensor 32, (b) programmed time or (c) a combination of the two. The desiccant 24 is deemed to be dry if the air flowing through it is in excess of 120F as, at this temperature, the desiccant 24 cannot hold a meaningful amount of moisture. Thus, the most efficient operation will pass the heated air through the desiccant 24 with the air being cooled by picking up moisture from the desiccant 24. When the moisture has been removed, the air is no longer efficiently cooled and the temperature at sensor 32 will increase, triggering a new cycle whenever the desired set point is achieved. Upon determining that the moisture in the desiccant 24 has been removed, regulators 26 and 28 are switched back to the positions shown in FIG. 1A so that internal air is drawn into the apparatus and the dried air is exhausted into the internal environment. Alternatively, the operation of the apparatus 10 may be halted so that no air is dried or warmed. It is to be noted that various configurations of the ducts 12a/12b and 16a/16b and manifolds 12 and 16 are contemplated by this invention as reasonably known to those of skill in the art.

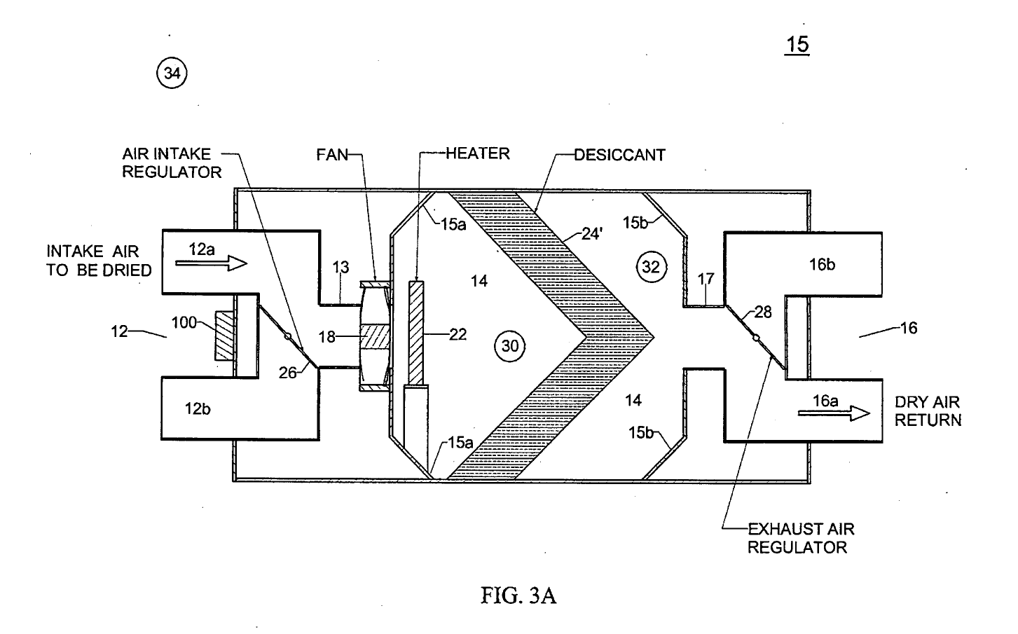

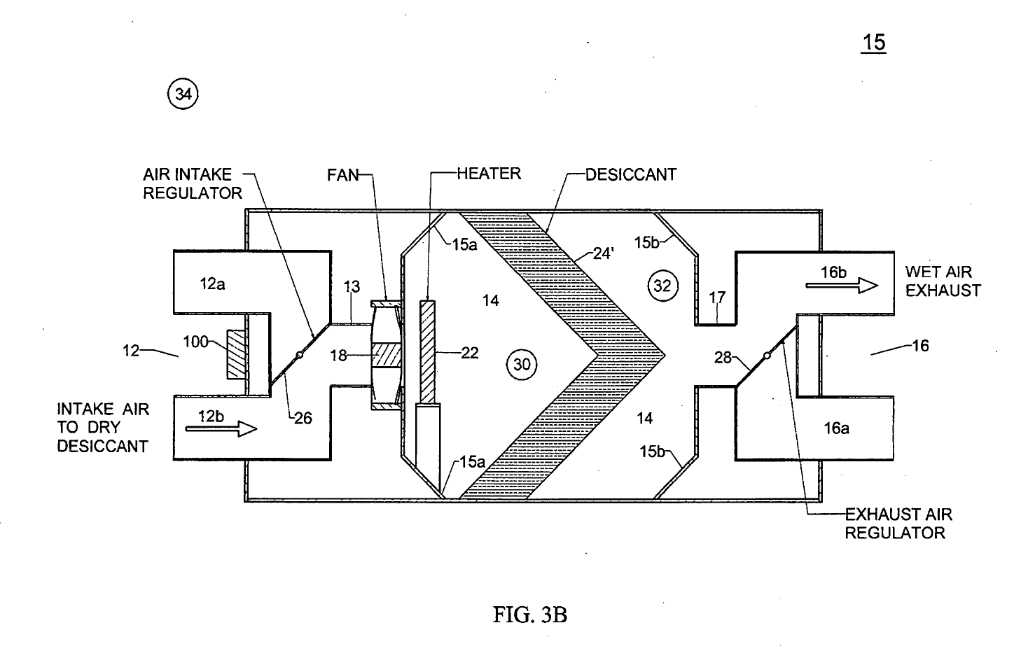

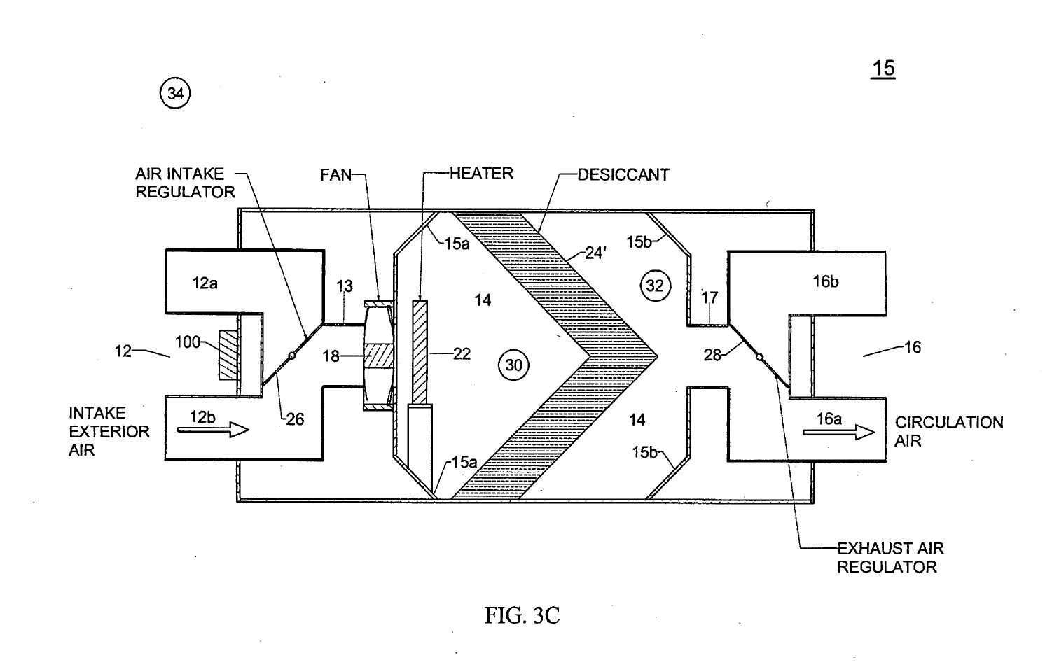

FIGS. 3A-3C depict a second embodiment of the apparatus of the present invention, represented as apparatus 15. In the apparatus 15, the desiccant 24′ is shaped in a “V” to maximize surface area and decrease the static pressure of air flow across the desiccant 24′. This configuration of the apparatus 15 permits increased flexibility in choice of fan 18 as the static pressure across the desiccant 24′ can be a limiting factor in fan 18 selection. Various other shapes or arrangements of the desiccant 24′ designed to maximize surface area and decrease the static pressure of air flow across the desiccant 24′ can be envisaged by those skilled in the art. For example, the desiccant 24′ may be arranged in thin slices rather than in a solid block.

In FIG. 3A, the air flow and valve position of the drying cycle in the apparatus 15 is shown. During the drying cycle, the fan 18 is on, and the heater 22 is off. Intake air to be dried is brought through the intake manifold 12 and moved by the fan 18 through the desiccant 24′. The desiccant 24′ removes water vapor from the air by adsorption and dry air is exhausted through the output manifold 16 into the environment desired to be dried.

The reactivation cycle using the apparatus 15 of the present invention is shown in FIG. 3B. During the reactivation cycle, the fan 18 and heater 22 are both on. Intake air to dry the desiccant 24′ is drawn through the intake manifold 12 based on the position of the regulator 26. The air is heated by the heater 22 and pushed by the fan 18 through the desiccant 24′. The desiccant 24′ releases water to the warmed air, and wet air is exhausted through the output manifold 16. The wet air is exhausted outside the environment being dried (such as outside of the recreational vehicle) based on the position of the regulator 28.

FIG. 3C illustrates use of the apparatus 15 of the present invention as an air circulation apparatus. During the air circulation option, the fan 18 is on and the heater 22 is off Intake exterior air (the air used to reactivate the desiccant 24′) is drawn through the intake manifold 12 based on the position of regulator 26. The air is moved by the fan 18 through the desiccant 24′ but the humidity of the air is not changed. The air is exhausted through the output manifold 16 into the environment (i.e. into a compartment of a boat, rather than outside of the boat, for example), based on the position of regulator 28. In this mode, the desiccant 24 will pickup and hold any moisture it can (until full), but will not be reactivated so, while there is some change to the air, it is minimal over any length of time. Alternatively, the heater 22 may be activated and used to introduce a small amount of heat into the circulating air. In this mode, the desiccant 24 will be reactivated and remain reactivated during the length of the heating period. This capability is an optional secondary function of the apparatus of the present invention that may be suitable in situations such as, for example, a military control vehicle for the control of unmanned aircraft, where there are many electronic devices which benefit from having dry air, but might need a small amount of additional heat for use in cold climates.

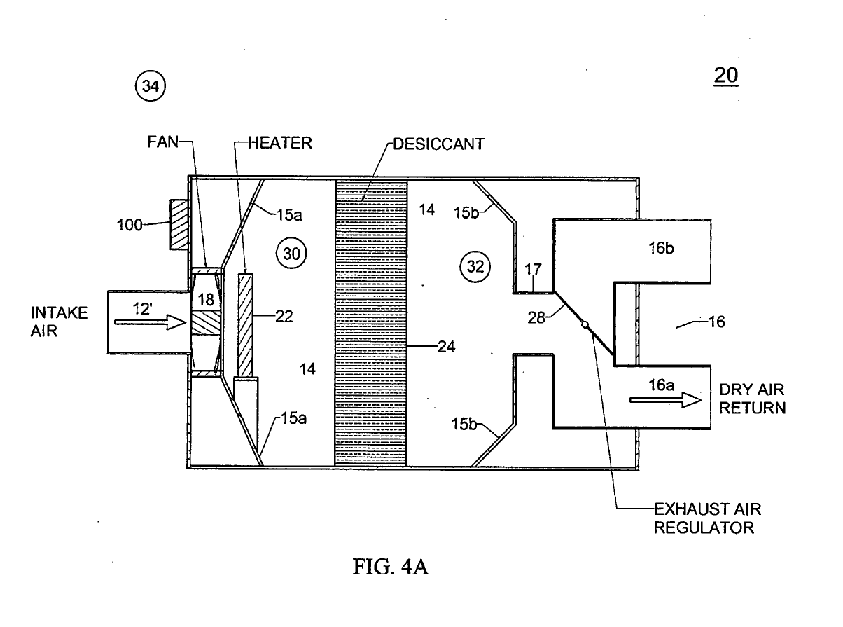

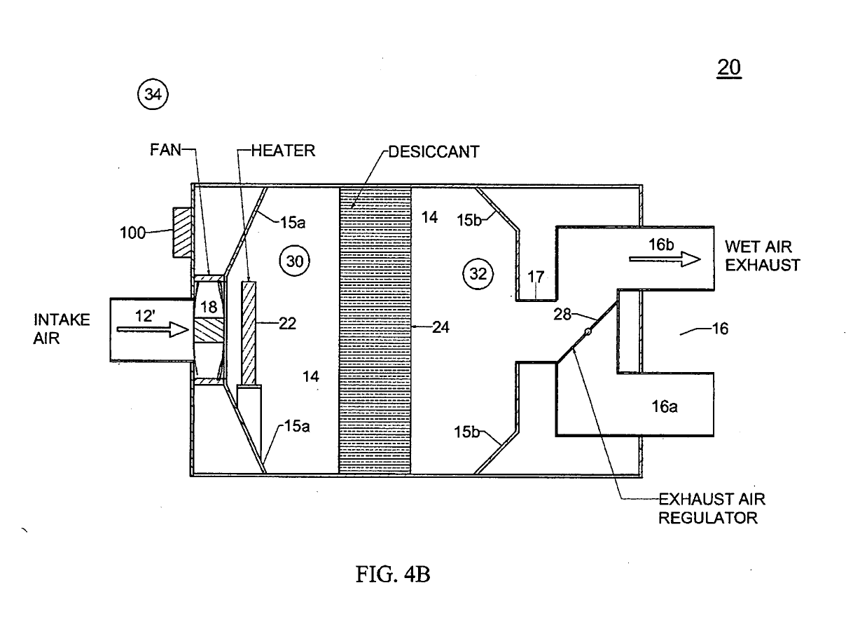

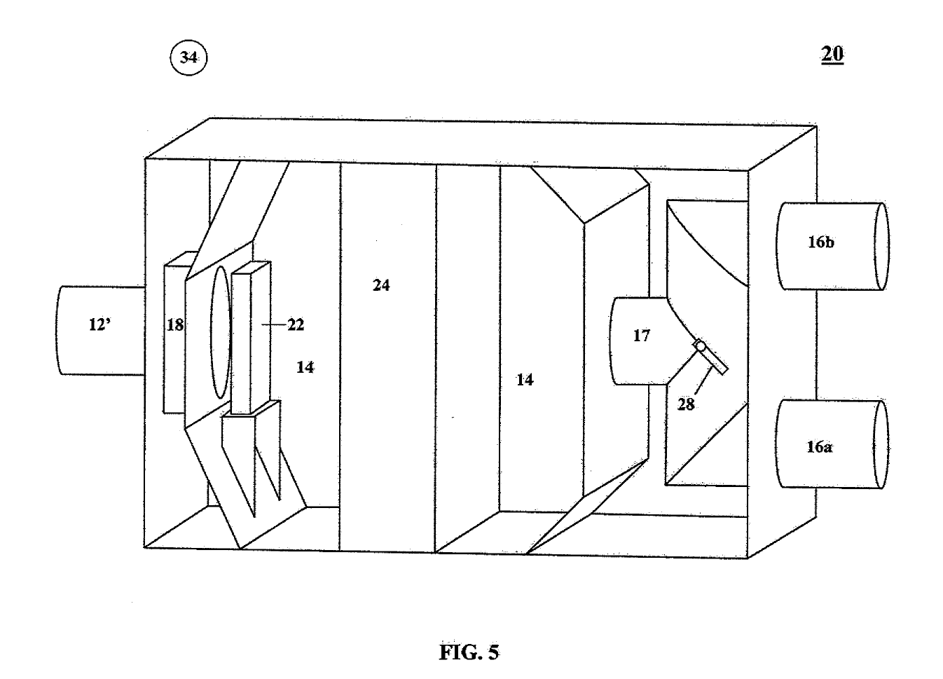

FIGS. 4A-5 illustrate a third embodiment of the present invention. Apparatus 20 includes a single intake duct 12′. The apparatus 20 in FIG. 4A includes two sensors 30 and 32. Sensors 30 and 32 are placed on opposite sides of the desiccant 24 in the chamber 14 to measure the temperature and/or humidity of the air in the chamber 14 on either side of the desiccant 24. The apparatus 20 could also be configured with an external sensor 34, or with no sensors.

During the drying/conditioning cycle of the apparatus 20 shown in FIG. 4A the fan 18 is on and the heater 22 is off. Intake air to be dried is brought through the intake duct 12′ and moved by the fan 18 through the desiccant 24. The desiccant 24 removes water vapor from the air by adsorption, and dry air is exhausted through the output manifold 16. The dry air is exhausted into the environment desired to be dried, based on the position of regulator 28.

The reactivation cycle using the apparatus 20 of the present invention is shown in FIG. 4B. During the reactivation cycle, the fan 18 and heater 22 are both on. Intake air to dry the desiccant 24 is drawn through the intake duct 12′. The air is heated by the heater 22 and moved by the fan 18 through the desiccant 24. The desiccant 24 releases water to the warmed air, and wet air is exhausted through the output manifold 16. Generally, the wet air is exhausted outside the environment being dried (such as outside of the boat), based on the position of regulator 28. It is to be noted that various configurations of the ducts 12′ and 16a/16b and manifold 16 are contemplated by this invention as reasonably known to those of skill in the art.

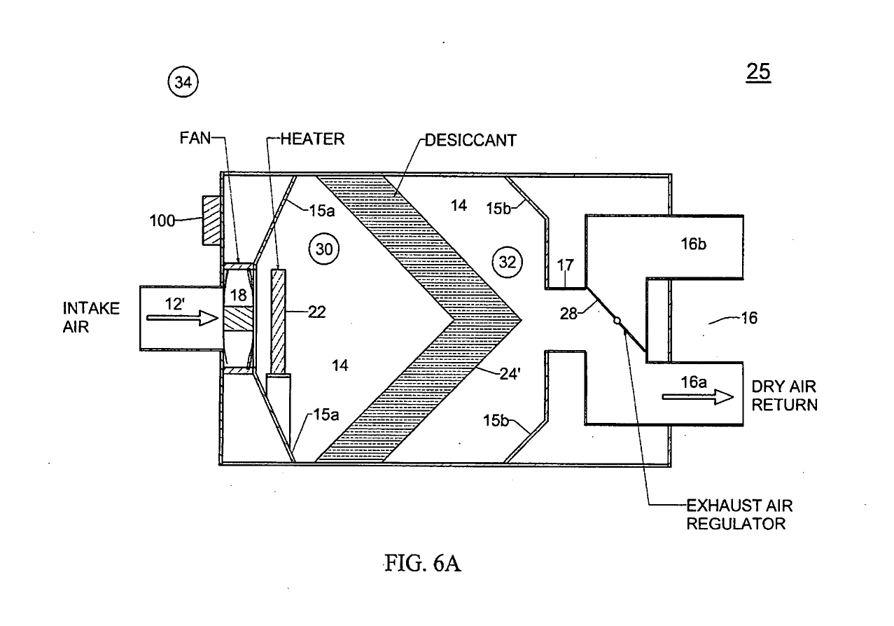

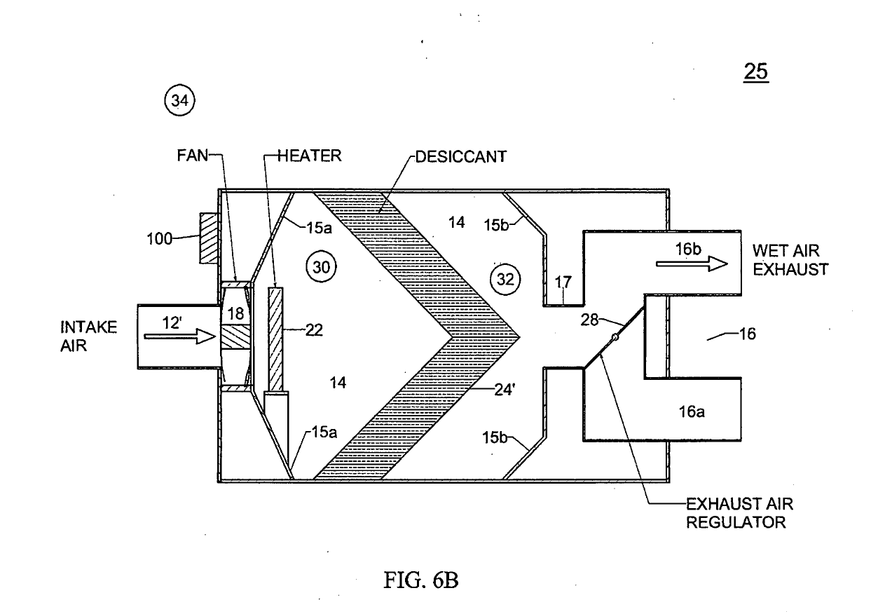

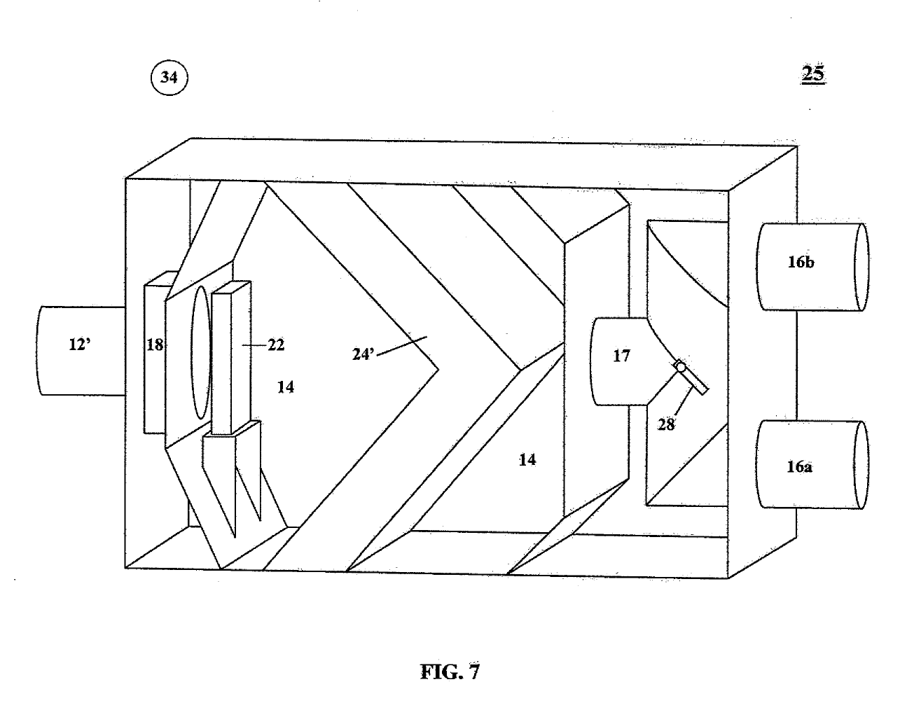

FIGS. 6A-7 depict a fourth embodiment of the apparatus of the present invention. Apparatus 25 includes desiccant 24′ in a “V” shape to maximize surface area and decrease the static pressure of air flow across the desiccant 24′. This configuration of the apparatus 25 permits increased flexibility in choice of fan 18 as the static pressure across the desiccant 24′ can be a limiting factor in fan 18 selection. Various other shapes or arrangements of the desiccant 24′ designed to maximize surface area and decrease the static pressure of air flow across the desiccant 24′ can be envisaged by those skilled in the art, such as thin slices of desiccant 24′, for example.

In FIG. 6A, the air flow and valve position of the drying cycle is shown. During the drying cycle, the fan 18 is on, and the heater 22 is off. Intake air to be dried is brought through the intake manifold 12′ and pushed by the fan 18 through the desiccant 24′. The desiccant 24′ removes water vapor from the air by adsorption, and dry air is exhausted through the output manifold 16. The dry air is exhausted into the environment desired to be dried, based on the position of regulator 28.

The reactivation cycle using the apparatus 25 of the present invention is shown in FIG. 6B. During the reactivation cycle, the fan 18 and heater 22 are both on. Intake air to dry the desiccant 24′ is drawn through the intake duct 12′. The air is heated by the heater 22 and pushed by the fan 18 through the desiccant 24′. The desiccant 24′ releases water to the warmed air, and wet air is exhausted through the output manifold 16. The wet air is exhausted outside the environment being dried (such as outside of a building), based on the position of regulator 28. FIG. 7 is a three-dimensional view of the apparatus 25 shown in FIGS. 6A and 6B.

Any of the embodiments of the invention described above may be modified and still remain within the scope of the invention. For example, the dehumidifier may include one or more air filters, either internal air filters or external, in-line air filters. The desiccant 24, 24′may be a single, solid block or may include thin slices of desiccant arranged to form a pocket. This and other alternative configurations could decrease the static pressure of air flow through the desiccant.

The drying and reactivation cycles of any of the embodiments of the invention can be modulated with a control process that permits complete control and/or separation of the drying and reactivation cycles in order to maximize the efficiency of the dehumidifier. For example, the apparatus 10/15/20/25 may include a controller 100 configured to carry out one or more selectable control sequences associated with drying, reactivation or other function(s). The controller may be any sort of control device, such as a computer device, microcontroller, or the like, programmable to perform specific functions associated with the drying/reactivation processes. The controller is connectable to one or more components of the apparatus including, but not limited to, one or more timers, the regulators 26 and 28 (for the four-duct version; only regulator 28 for the three-duct version), the fan 18 and the heater 22, as well as any one or more of the sensors. The sensors may provide information used in a feedback loop configuration with the controller to provide input in a control algorithm to regulate movement of the regulators 26/28 (for the four-duct version; only regulator 28 for the three-duct version), and the turning on and off of the fan 18 and/or the heater 22. Those of skill in the art will recognize suitable forms of such a type of controller.

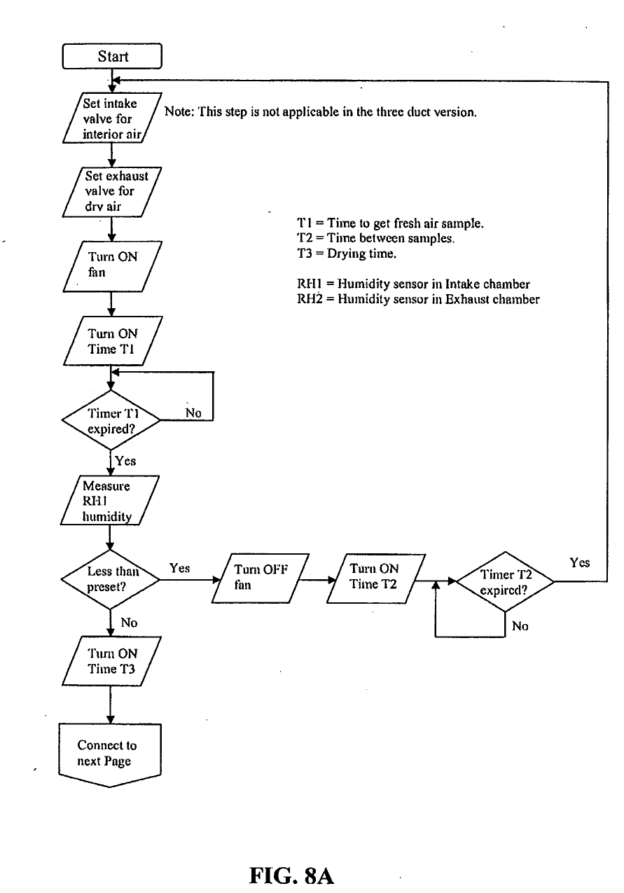

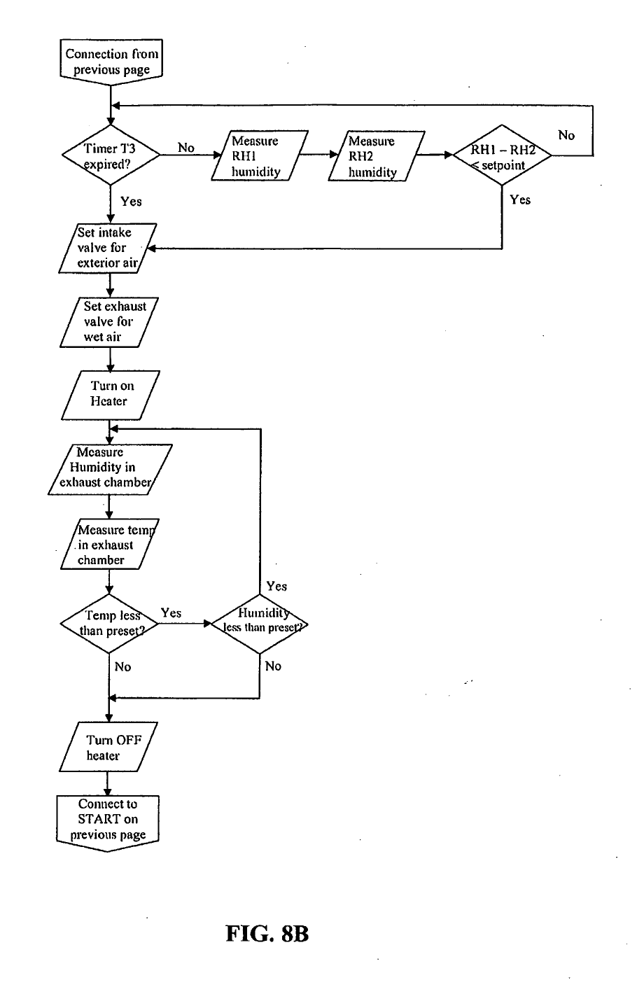

In an example of the method of the present invention, the control sequence modulates the timing and change of the drying and reactivation cycles by controlling the position of the valves and the function of the heater and/or fan. In some embodiments, the control process may be controlled by any suitable computer or microprocessor known in the art. One suitable control sequence is illustrated in FIGS. 8A and 8B, although those skilled in the art can easily envisage other control sequences suitable for use in the dehumidifier apparatus and method of the present invention. For example, while the example sequences contemplate the consideration of temperature and/or humidity in the control of the apparatus, it is also to be understood that the operation of the apparatus may be regulated based on time alone. Such an arrangement may be less expensive to manufacture.

As shown in FIGS. 8A and 8B, the control sequence functions as follows when there is no external sensor 34 as part of the apparatus. When the four-duct version of the apparatus 10 or 15 is activated, the intake regulator 26 is set to intake air to be dried (e.g., the position of regulator 26 in FIGS. 1A and 3A), and the exhaust regulator 28 is set to exhaust the dried air into the desired environment (bedroom, boat cabin, motor home, etc.) (e.g., the position of regulator 28 in FIGS. 1A and 3A). For the three-duct version of the apparatus 20 or 25, just the exhaust regulator 28 is set to exhaust the dried air in the desired environment (e.g., the position of regulator 28 in FIGS. 4A and 6A). The control sequence turns the fan 18 on so that air is moved into the apparatus at the apparatus intake. In the sample sequence shown in FIGS. 8A and 8B, a first timer T1 is turned on. First timer T1 sets the interval of time that permits the apparatus to deliver air to be conditioned into the chamber 14. Once that time interval has run, the sensor RH1 (sensor 30) in the intake end of the chamber 14 measures the humidity of the incoming air. If it is less than a pre-determined value, the fan 18 is turned off and a second timer T2 is turned on. Second timer T2 sets the interval of time for further intake of air into the chamber 14. Once that time interval has run, the control process initialization is repeated so that the humidity measurements in the intake end of the chamber 14 are made. Once the humidity measured there exceeds the pre-determined level, a third timer T3 is turned on. Timer T3 sets the interval of time that moisture is being removed from the air by the desiccant 24. During that time interval, the sensor RH1 (sensor 30) in the intake end of the chamber 14 measures the humidity of the incoming air and sensor RH2 (sensor 32) in the output end of the chamber 14 measures the humidity of the air exiting the desiccant 24 prior to exhausting at the output end of the apparatus. If the humidity differential between the two humidity sensing locations is not below a preset level, sensing continues and no changes in any of the regulators 26/28, fan 18 or heater 22 are made. When the humidity differential exceeds the preset level, or the time interval associated with Timer T3 times out, the control process begins the reactivation cycle by switching the position of the intake regulator 26 to receive exterior air (e.g., the position of regulator 26 in FIGS. 1B and 3B) for the four-duct version. This step is omitted for the three-duct version. Next, the control process switches the position of the output regulator 28 to exhaust “wet” air (e.g., the position of regulator 28 in FIGS. 1B and 3B for the four-duct version, and FIGS. 4B and 6B for the three-duct version) and the heater 22 is activated. Sensor 32 on the exhaust side of the chamber 14 measures the air temperature and/or humidity in the chamber 14. When the air temperature and/or humidity has reached a preset level, meaning that the desiccant 24 has been reactivated, the heater 22 is switched off and the reactivation cycle is complete. The process may be repeated as necessary or desired, and the option exists to keep the fan 18 and/or the heater 22 operating if that is of interest.

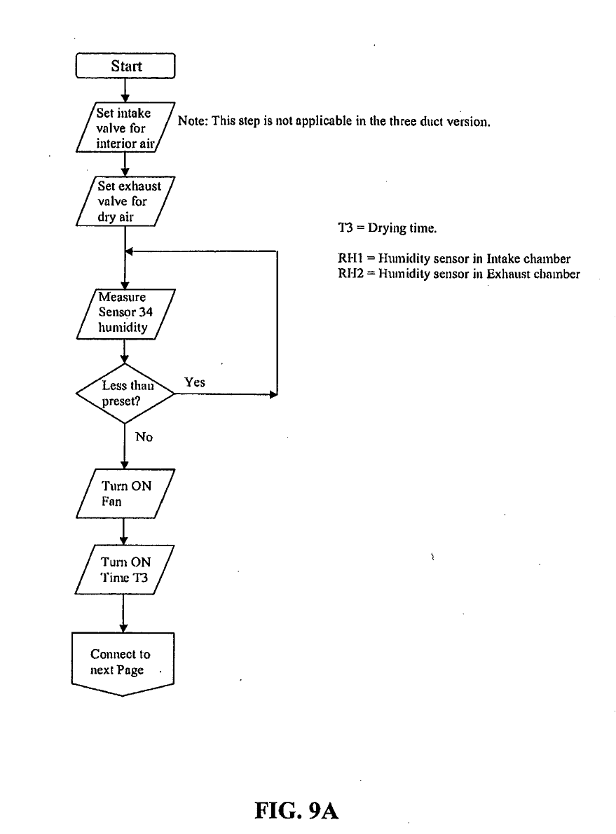

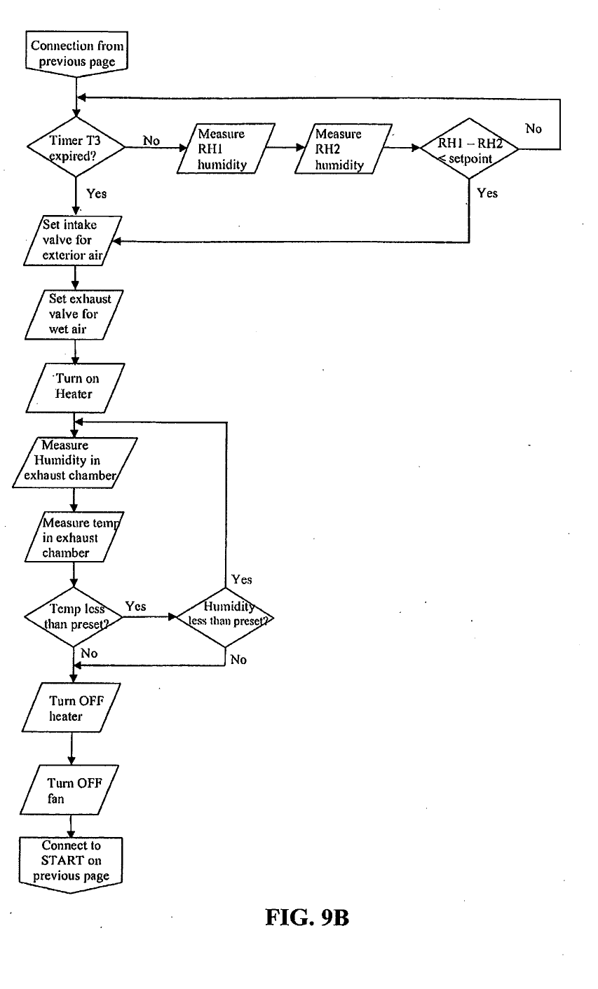

As shown in FIGS. 9A and 9B, the control sequence functions as follows when the apparatus includes external sensor 34 and that sensor is used. Initially, the external sensor 34 senses the relative humidity outside of the apparatus. If the relative humidity is below a preset level, the apparatus is off. When the external sensor 34 senses that the external relative humidity is above the preset level, a switch is actuated to turn the apparatus on. When the four-duct version of the apparatus 10 or 15 is activated, the intake regulator 26 is set to intake air to be dried (e.g., the position of regulator 26 in FIGS. 1A and 3A), and the exhaust regulator 28 is set to exhaust the dried air into the desired environment (bedroom, boat cabin, motor home, etc.) (e.g., the position of regulator 28 in FIGS. 1A and 3A). For the three-duct version of the apparatus 20 or 25, just the exhaust regulator 28 is set to exhaust the dried air in the desired environment (e.g., the position of regulator 28 in FIGS. 4A and 6A). The external sensor 34 continues to sense the relative humidity outside of the apparatus. The control sequence turns the fan 18 on so that air is moved into the apparatus at the apparatus intake. In the sample sequence shown in FIGS. 9A and 9B, a timer T3 is turned on. Timer T3 sets the interval of time that moisture is being removed from the air by the desiccant 24. As long as the relative humidity sensed by the external sensor 34 remains above the preset level, the apparatus remains on. During the T3 time interval, the sensor RH1 (sensor 30) in the intake end of the chamber 14 measures the humidity of the incoming air and sensor RH2 (sensor 32) in the output end of the chamber 14 measures the humidity of the air exiting the desiccant 24 prior to exhausting at the output end of the apparatus. If the humidity differential between the two humidity sensing locations is not below a preset level, sensing continues and no changes in any of the regulators 26/28, fan 18 or heater 22 are made. When the humidity differential exceeds the preset level, or the time interval associated with Timer T3 times out, the control process begins the reactivation cycle by switching the position of the intake regulator 26 to receive exterior air (e.g., the position of regulator 26 in FIGS. 1B and 3B) for the four-duct version. This step is omitted for the three-duct version. Next, the control process switches the position of the output regulator 28 to exhaust “wet” air (e.g., the position of regulator 28 in FIGS. 1B and 3B for the four-duct version, and FIGS. 4B and 6B for the three-duct version) and the heater 22 is activated. Sensor 32 on the exhaust side of the chamber 14 measures the air temperature and/or humidity in the chamber 14. When the air temperature and/or humidity has reached a preset level, meaning that the desiccant 24 has been reactivated, the heater 22 and the fan 18 are switched off and the reactivation cycle is complete. The process may be repeated as necessary or desired, and the option exists to keep the fan 18 and/or the heater 22 operating if that is of interest. In effect, the information obtained from the external sensor 34 is used to determine whether to turn the apparatus on or off. The timers and the internal sensors are used to switch between the drying and reactivation cycles.

The present invention also encompasses a method for dehumidifying a desired area, including the steps of introducing an apparatus of the present invention into a desired area, dehumidifying the area by running a drying cycle of the dehumidifying apparatus of the present invention, and running a reactivation cycle of the dehumidifying apparatus of the present invention. The drying and reactivation cycles are repeated in the method as necessary until a desired level of humidity in the area is achieved. The method of the present invention is advantageous because the apparatus used in the method is cost efficient to manufacture and purchase, can be scaled down easily, and offers higher moisture removal efficiency than some systems known in the art.

The present invention has been described with respect to various examples. Nevertheless, it is to be understood that various modifications may be made without departing from the spirit and scope of the invention. All equivalents are deemed to fall within the scope of this description of the invention.

What is claimed is:

1. An apparatus for dehumidifying a desired area, the apparatus comprising:
a. a chamber including an intake and an output, wherein the output includes a first output duct and a second output duct;
b. a desiccant positioned within the chamber between the intake and the output;
c. a device for moving air positioned between the intake and the output;
d. a device for warming air positioned between the intake and the desiccant; and
e. an air flow regulator arranged to regulate the output of air passing from the chamber to the first output duct or the second output duct.

2. The apparatus of claim 1, wherein the intake includes a first intake duct and a second intake duct, wherein the apparatus further includes a second air flow regulator arranged to regulate the intake of air into the chamber.

3. The apparatus of claim 1, further comprising one or more timers.

4. The apparatus of claim 1, further comprising one or more sensors for measuring temperature, humidity or both.

5. The apparatus of claim 4, wherein at least one of the sensors is positioned outside of the chamber.

6. The apparatus of claim 1, further comprising one or more air filters.

7. The apparatus of claim 1, wherein the desiccant is a moisture adsorbing honeycomb block.

8. The apparatus of claim 1, wherein the desiccant is configured to decrease the static pressure of air flow through the desiccant.

9. The apparatus of claim 8, wherein the desiccant is V-shaped.

10. The apparatus of claim 1, further comprising a controller to regulate the movement of the air flow regulator.

11. The apparatus of claim 10, wherein the controller further regulates operation of the device for warming air and the device for moving air.

12. The apparatus of claim 10, wherein the controller is arranged to modulate operation of the apparatus between a first cycle for drying air and a second cycle for reactivation of the desiccant.

13. A method for dehumidifying a desired area, the method including the steps of:
(i) introducing an apparatus for dehumidifying into the desired area, the apparatus comprising a chamber including an intake and an output, wherein the output includes a first output duct and a second output duct, a desiccant positioned within the chamber between the intake and the output, a device for moving air positioned between the intake and the output, a device for warming air positioned between the intake and the desiccant and an air flow regulator arranged to regulate the output of air passing from the chamber to the first output duct or the second output duct;
(ii) running in the apparatus a first cycle for drying air;
(iii) running in the apparatus a second cycle for reactivating the desiccant; and
(iv) repeating steps (ii) and (iii) as many times as necessary until a desired level of humidity in the desired area is achieved.

14. The method of claim 13, wherein the apparatus includes a controller configured to enable modulation between the first cycle for drying air and the second cycle for reactivation of the desiccant.

15. The method of claim 13, wherein the apparatus includes a first intake duct and a second intake duct, wherein the apparatus further includes a second air flow regulator arranged to control the intake of air into the chamber.

16. The method of claim 13, wherein the apparatus includes one or more timers.

17. The method of claim 13, wherein the apparatus includes one or more sensors for measuring temperature, humidity, or both.
